(19) United States
(12) Patent Application Publication
(10) Pub. No.: US 2008/0302678 A1
(43) Pub. Date: Dec. 11, 2008

(54) Edible Food Composition and Various Packaging Arrangments

(76) Inventors: Rodney Darryl Hunwisk, New South Wales (AU); Kieron Dowd, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/910,194

(22) PCT Filed: Mar. 30, 2006
(86) PCT No.: PCT/AU2006/000421

§ 371 Date: Jun. 20, 2008

(30) Foreign Application Priority Data
Mar. 30, 2005 (AU) 2005901536
Sep. 28, 2005 (AU) 2005905355

(51) Int. Cl. B65D 77/08; B65D 1/36; B65D 81/32; A23K 1/18

(52) U.S. Cl. 206/222; 426/131

(57) ABSTRACT

A packaging system for food stuff comprising a primary container and a secondary container wherein said primary container is adapted for enclosure of said secondary container; said secondary container attached to an openable portion of said primary container.

The present invention relates to edible compositions or combinations and packaging of food items and, more particularly of such food items for pet animals.

### BACKGROUND

The keeping for pleasure, companionship and in some case usefulness of animals is a feature of many societies. The practice of feeding of such animals ranges from reliance of scraps and scavenging by the animal to specially prepared “gourmet” dishes, particularly for domestic pet animals such as cats and dogs.

The industry providing pre-cooked and packaged foods, particularly for cats and dogs is very large and extremely competitive. Manufacturers are continually in search of new marketing opportunities, products and packaging presentation.

Many such food preparations are of a consistency where they are messy and inconvenient to extract from their packaging and often a wasteful residue is left clinging to the inside surfaces of the packaging in such cases. Moreover many do not provided for a balanced diet desirable to maintain the health of an animal.

Yet other pet food preparations are of a single dry composition offering little variety in the diet of the consuming animal.

Animals frequently require vitamin, conditioning and regular various preventative and curative medicinal supplements. These are often difficult to administer and require inconvenient additional acquisition, storage and a discipline regime to maintain correct and regular dosage.

It is an object of the present invention to address or ameliorate some of the above disadvantages.

### BRIEF DESCRIPTION OF INVENTION

Accordingly in one broad form of the invention there is provided a packaging system for food stuff comprising a primary container and a secondary container wherein said primary container is adapted for enclosure of said secondary container; said secondary container attached to an openable portion of said primary container.

Preferably said primary container is a plastic container provided with a plastic peel-off cover.

Preferably said secondary container is a plastic sachet attached to the underside of said plastic peel-off cover.

Preferably said sachet is provided with a line of weakness adapted to split so as to provide an opening in at least one surface of said sachet when said plastic peel-off cover and said sachet are suitably manipulated.

Preferably said primary container is a tin can.

Preferably said secondary container is a plastic sachet attached to the underside of one end of said tin can.

Preferably said primary container is filled with prepared main ingredients for a meal.

Preferably said sachet is filled with an ancillary ingredient.

Preferably said ancillary ingredient is a sauce.

Preferably said ancillary ingredient is a gravy.

Preferably said ancillary ingredient is a condiment.

Preferably said ancillary ingredient is a flavouring agent.

Preferably said ancillary ingredient is a vitamin supplement.

Preferably said ancillary ingredient is a medicinal supplement.

Preferably said primary container filled with said prepared main ingredients is made available with a range of ancillary ingredients in said sachet.

Preferably said primary container is provided with indicia indicating contents of said sachet.

Accordingly in a further broad form of the invention there is provided a method of supplying an ancillary ingredient with prepared foodstuffs; said method including the steps of:
(a) providing a container system comprising of a primary container enclosing a secondary container,
(b) filling said primary container with main ingredients for a prepared meal,
(c) filling said secondary container with an ancillary ingredient for said prepared meal.

Preferably said primary container is a plastic container with a peel-off lid.

Preferably said secondary container is a sachet attached to an underside of said peel-off lid.

Preferably said primary container is a tin can.

Preferably said secondary container is a sachet attached to an underside of one end of said tin can.

In yet a further broad form of the invention there is provided a food product comprising an arrangement of packaging and a composition of food; said composition of food comprising at least one outer edible portion and at least one inner edible portion; said outer edible portion providing at least a partial containing enclosure for said at least one inner edible portion so as to allow extraction of said composition of food from said packaging in one contiguous whole.

Preferably said outer edible portion is comprised of a layer of crust-like material of a shape conforming to inside surfaces of at least a portion of said packaging.

Preferably said crust-like material is comprised of a hardened base portion and softer upwardly extending side portions.

Preferably said outer edible portion is adapted to retain said shape for the shelf life of said composition and between removal from said packaging and consumption.

Preferably at least one outer edible portion and said at least one inner edible portion are enclosed in a foil sachet; said sachet formed as an elongate sleeve of oval section; said sleeve closed at a first top end and a second bottom end; said closed top end provided with a tear off portion.

Preferably said at least one outer edible portion comprises a first outer portion and a second outer portion; each of said first and second outer portions shaped so as to leave a generally cylindrical space between them for filling with said a said inner edible portion; each of said outer and inner edible portions extending substantially the length of said elongate sleeve.

Preferably said composition of food is comprised of any ingredients suitable for consumption by domestic pet animals.

Preferably said composition of food includes a separate food ingredient.

Preferably wherein said separate food ingredient is a gravy.

Preferably said separate food ingredient is a sauce.

Preferably said separate food ingredient is enclosed in a sachet.

Preferably said separate food ingredient is enclosed in a second compartment located in lower section of said packaging.

Preferably said packaging is comprised of a base portion and a closure portion.

Preferably said base portion is provided with a first closure portion sealing against an upper rim of said base portion and a second closure portion sealing said second compartment.

Preferably said first closure portion is comprised of a sheet foil or plastic peel-off lid attached to said rim of said base portion by suitable adhering means.

Preferably said second closure portion is a sheet of foil attached at an intermediate step or shoulder of said base portion so as to seal said second compartment.

Preferably said sachet is attached to the underside of said peel-off lid.

Preferably said sachet is provided loose; said sachet lying in a depression under said peel-off lid.

Preferably said packaging is a cylindrical can.

Preferably said sachet is attached to the inside surface of the upper end of said cylindrical can.

Preferably said sachet is provided loose; said sachet lying in a depression under said upper end of said cylindrical can.

Preferably said at least one inner edible portion is comprised of a biscuit-like material.

Preferably said at least one inner edible portion is provided with a cavity adapted to retain a protein source.

Preferably said biscuit-like material is formed in the likeness of a bone.

Preferably said outer edible portion is substantially comprised of a meat preparation.

Preferably said packaging is comprised of a plastic sheath shaped so as to resemble a sausage.

Preferably said plastic sheath is provided with a zipper portion extending substantially the length of said sheath; said zipper portion adapted to allow ejection of said edible composition from said sheath as a contiguous whole.

Preferably said composition of food includes a separate supplement.

Preferably said supplement is a vitamin supplement.

Preferably said supplement is a condition enhancing supplement.

Preferably said supplement is a curative medicinal supplement.

Preferably said supplement is a preventative medicinal supplement.

Preferably said supplement is retained in a cavity formed in an edible portion of said composition of food.

Preferably said supplement is retained in a sachet.

Preferably said sachet is attached to the inside of a cover portion of said packaging.

In yet a further broad form of the invention there is provided a method of presenting a food composition to a domestic pet animal; said method including the steps of:
(a) preparing said food composition as an inner edible portion and an outer edible portion,
(b) including said food composition in a packaging comprising a base portion and a peel-off lid portion,
(c) removing said food composition from said packaging,
(d) placing said food composition for consumption by said animal.

Preferably said outer edible portion is in the form of a layer of crust-like material shaped so as to conform to inside surfaces of said packaging.

Preferably said inner edible portion is comprised of any composition of food ingredients suitable for feeding of said domestic pet animal.

In yet a further broad form of the invention there is provided a method of presenting a packaged food composition and a mixable separate food ingredient to a domestic pet animal; said method including the steps of:

(e) preparing said food composition for enclosure in a package comprising a base portion and a peel-off lid portion,
(f) enclosing said mixable separate food ingredient in a sachet,
(g) attaching said sachet to the underside of said peel-off lid portion,
(h) removing said food composition from said package,
(i) removing said mixable food ingredient from said sachet for distribution over said food composition.

In yet a further broad form of the invention there is provided a nutritional composition for animals comprising three juxtaposed nutrient structures; a first nutrient structure comprising a liquid carrier containing a protein source; a second nutrient structure comprising a substantially solid carrier containing a fibre source; a third nutritional structure comprising a bulk gel carrier containing a carbohydrate source.

Preferably said protein source is at least partially provided in a separate gravy food ingredient.

Preferably said protein source is at least partially provided in a separate sauce food ingredient.

Preferably said fibre source is substantially provided in a biscuit-like portion of said composition.

Preferably said carbohydrate source is substantially provided in said biscuit like portion of said composition.

Preferably said substantially solid carrier forms at least a partial enclosure for said bulk gel carrier; said partial enclosure including a base portion and side portions.

Preferably said substantially solid carrier forms a complete enclosure of said bulk gel carrier.

Preferably said composition is enclosed in packaging.

Preferably said liquid carrier is enclosed in a sachet included within said packaging.

Preferably said packaging is comprised of a base portion and at least one closure portion.

Preferably said base portion and said at least one closure portion are formed of plastic or foil.

Preferably said liquid carrier is enclosed in a cavity provided in said substantially solid carrier.

Preferably said liquid carrier is enclosed in a second sealed compartment of said packaging.

Preferably said substantially solid carrier is enveloped in said bulk gel carrier.

Preferably said composition is enclosed in packaging.

Preferably said packaging is comprised of a plastic sheath.

In yet a further broad form of the invention there is provided a nutritional composition for animals comprising two juxtaposed nutrient structures; a first nutrient structure comprising a liquid carrier containing a protein source and a second nutrient structure comprising a substantially solid carrier containing a fibre source.

Preferably said composition includes a further nutrient structure comprising a bulk gel carrier containing a carbohydrate source.

In yet a further broad form of the invention there is provided a nutritional composition for animals comprising two juxtaposed nutrient structures; a first nutrient structure comprising a substantially solid carrier containing a fibre source and a second nutritional structure comprising a bulk gel carrier containing a carbohydrate source.

Preferably said composition includes a further nutrient structure comprising a liquid carrier containing a protein source.

In yet a further broad form of the invention there is provided a nutritional composition for animals comprising two juxtaposed nutrient structures; a first nutrient structure comprising a liquid carrier containing a protein source and a second nutritional structure comprising a bulk gel carrier containing a carbohydrate source.

Preferably said composition includes a further nutrient structure comprising a substantially solid carrier containing a fibre source.

In yet a further broad form of the invention there is provided a packaging for a nutritional composition for animals; said packaging comprising at least a first sheet and a second sheet of a foil material; each said first sheet and said second sheet wrapped to form an elongate generally oval section envelope wherein corresponding pairs of opposing edges of each said sheet are brought together to form a common seam extending the length of said oval section so as to define a first inner enclosure and a second outer enclosure.

Preferably upper and lower ends of each said elongate oval section of said inner and outer enclosures are sealed.

Preferably an upper portion of said packaging is provided with a frangible area adapted for removal of said upper portion.

Preferably said inner enclosure is adapted to contain a flowable nutritional substance; said second outer enclosure is adapted to contain a relatively solid kibble composition.

In a further broad form of the invention there is provided a packaging for a nutritional composition for animals; said packaging formed of layers of at least three generally rectangular sheets of a foil material; each of said sheets joined together at corresponding first pairs of opposing edges; and wherein dimensions between said first pairs of opposing edges of successive sheets increase from a first uppermost sheet to a lowermost sheet; said first uppermost sheet forming a generally flat surface with each successive lower sheet assuming a concave form so as to form a first enclosure between said uppermost sheet and an intermediate lower sheet and a second enclosure between said intermediate lower sheet and said lowermost sheet.

In yet a further broad form of the invention there is provided a packaging for a nutritional composition for animals; said packaging shaped in section as dog bone; said packaging divided into three compartments comprising two outer compartments and middle compartments; said packaging further comprising a rear closure panel and a front closure panel.

Preferably said front closure panel includes a removable portion.

Preferably said outer compartments are adapted to contain relatively solid kibble nutritional compositions; said middle compartment adapted to contain a flowable substance.

Preferably said flowable substance is a gravy.

Preferably said flowable substance is a therapeutic substance.

Preferably said two outer compartments contain relatively flowable edible compositions.

In yet a further broad form of the invention there is provided a packaging for a nutritional composition for animals; said packaging shaped in section as a fish; said packaging divided into three compartments comprising two outer compartments and a middle compartment; said packaging comprising a base portion; said outer compartments and a middle compartment defined by an outer shell with dividing elements extending upwards from said base portion; said packaging further including a sealing cover releasably attached to upper edges of said outer shell and said dividing elements.

Preferably said outer compartments are adapted to contain flowable edible compositions; said middle compartment adapted to contain a relatively solid kibble nutritional composition.

Preferably said flowable composition is a gravy.

Preferably said flowable composition is a therapeutic substance.

Preferably said middle compartment contains a relatively flowable edible compositions; said two outer compartments containing a relatively solid edible composition.

In yet a further broad form of the invention there is provided a packaging containing at least two edible compositions for pet animals; said packaging in the form of a container comprising a base portion and side portions extending upwardly from said base portion; said container divided into an upper compartment containing a first of said at least two edible compositions, and a lower compartment containing a second of said at least two edible compositions; said upper compartment and said lower compartment separated by a dividing element; wherein a first of said at least two edible compositions comprises an outer edible portion at least partially enclosing an inner edible portion, and wherein a second of said at least two edible compositions comprises a flowable nutritional substance.

Preferably said outer edible portion comprises a crust of biscuit-like material forming a base portion and at least upwardly extending side portions; said base portion and said side portions substantially conforming to inner surfaces of said upper compartment.

In yet a further broad form of the invention there is provided an edible composition and packaging for pet animals; said packaging in the form of a bowl-like outer shell comprising a base portion and sides extending upwardly to an outer peripheral rim; said packaging including an integrally formed internal receptacle extending upwardly from said base portion to an inner peripheral rim; said bowl-like outer shell and said internal receptacle forming a first outer edible composition containing portion and a second internal edible composition containing portion.

Preferably said outer rim and said inner rim lie in a common plane.

Preferably said packaging further includes a cover portion adapted for sealing engagement with said outer rim and said inner rim.

Preferably said outer edible composition comprises a generally solid food composition.

Preferably said inner edible composition comprises a flowable food composition.

Preferably said generally solid food composition comprises an outer crust of biscuit-like material at least partially enclosing an inner kibble and gel composition.

### BRIEF DESCRIPTION OF DRAWINGS

Embodiments of the present invention will now be described with reference to the accompanying drawings wherein:

FIG. 1 is a sectioned elevation view of a packaging for an edible composition according to a first preferred embodiment of the present invention.

FIG. 2 is a perspective view of the packaging of FIG. 1 at a first stage of use.

FIG. 3 is a perspective view of the packaging of FIGS. 1 and 2 at a second stage of use.

FIG. 4 is a cross sectioned elevation view of a packaging for an edible composition according to a second preferred embodiment of the present invention.

FIG. 5 is a perspective view of the packaging of FIG. 4 at a first stage of use.

FIG. 6 is a cross section elevation through a preferred embodiment of an edible composition and packaging according to the invention.

FIG. 7 is a perspective view of the edible composition and packaging of FIG. 6 with the peel-off cover portion removed.

FIG. 8 is a side elevation view of the edible composition and packaging of FIGS. 6 and 7 with the peel-off cover portion partially removed from the packaging revealing a sachet of separate food ingredient attached to the underside of the cover.

FIG. 9 is a sectioned view of a further embodiment of an edible composition and packaging according to the invention.

FIGS. 10 and 11 are sectioned views of further embodiments of an edible composition and packaging according to the invention.

FIG. 12 is a sectioned view of yet a further embodiment of an edible composition and packaging according to the invention.

FIG. 13 is a sectioned view of a further embodiment of an edible composition and packaging.

FIG. 14A is a sectioned view of a further embodiment of an edible composition and packaging.

FIG. 14B is a perspective view of the edible composition and packaging of FIG. 14A.

FIG. 15A is a sectioned view of a further embodiment of an edible composition and packaging.

FIG. 15B is a perspective view of the edible composition and packaging of FIG. 15A.

FIG. 16A is a sectioned view of a further embodiment of an edible composition and packaging.

FIG. 16B is a perspective view of the edible composition and packaging of FIG. 16A.

FIG. 17A is a sectioned view of a further embodiment of an edible composition and packaging.

FIG. 17B is a perspective view of the edible composition and packaging of FIG. 17A with a front closure panel removed.

FIG. 17C is a perspective view of the edible composition and packaging of FIG. 17A with a pull-off portion of a front closure panel removed,

FIG. 18 is a perspective view of a further preferred embodiment of a packaging for an edible composition,

FIG. 19 is a sectioned view of the packaging of FIG. 18 with two edible compositions.

FIGS. 20A and 20B are perspective views of a further preferred embodiment of a packaging for an edible composition,

FIG. 21 is a plan view of the packaging of FIGS. 20A and 20B with cover removed.

### DETAILED DESCRIPTION OF PREFERRED EMBODIMENTS

The present invention seeks to provide combinations of three main elements desirable in a pet food, that is, taste, texture and nutrition, in a variety of compositions and packaging. The three elements according to the present invention may be incorporated in any one or in all of a number of disparate edible components within any of the preferred embodiments of packaging described in detail below.

### First Preferred Embodiment

With reference to FIGS. 1 and 2, a packaging system 10 according to a first preferred embodiment of the invention comprises a plastic primary container 12 with a peel-off plastic cover 14. Typically, plastic cover 14 may be provided with a pull-up tab 16 provided at a corner of the container 12, or in the case of a circular or oval container, at a suitable projecting extension. Such a tab typically also overlies a tab portion 18 of the rim 20 of the container 12 and divided from the main part of the rim 18 by a weakened line 22 adapted to allow the tab portion of the rim to be separated and together with the tab portion of the cover provide a grasping portion for pulling the cover free of the rim.

Primary container 12 and cover 14 enclose a secondary container attached to the underside of the cover 14 in the form of a sachet 24, for containing ancillary ingredient 26. Preferably, sachet 24 is so sized relative to the volume of container 12 as to provide a satisfactory effect of the ancillary ingredient on the primary ingredients 28 of the container when the contents of the sachet are applied to those contents.

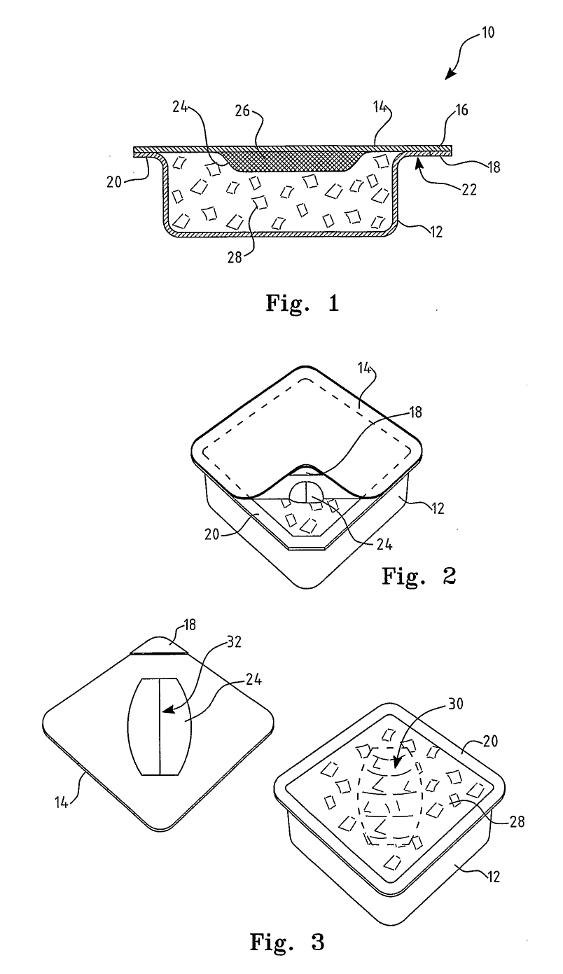

In this first embodiment, as best seen in FIG. 3, the sachet 24 is accommodated by a depression 30 in primary contents 28. In at least one preferred form of this embodiment, sachet 24 may be provided with a split line 32 substantially extending the length of the underside 34 of the sachet. Split line 32 is a zone of weakened plastic adapted to split when the flexible peel-off cover 14 is manipulated by bending action transverse to the direction of the split line so as to provide an opening for the ejection of the ancillary ingredient.

### Second Preferred Embodiment

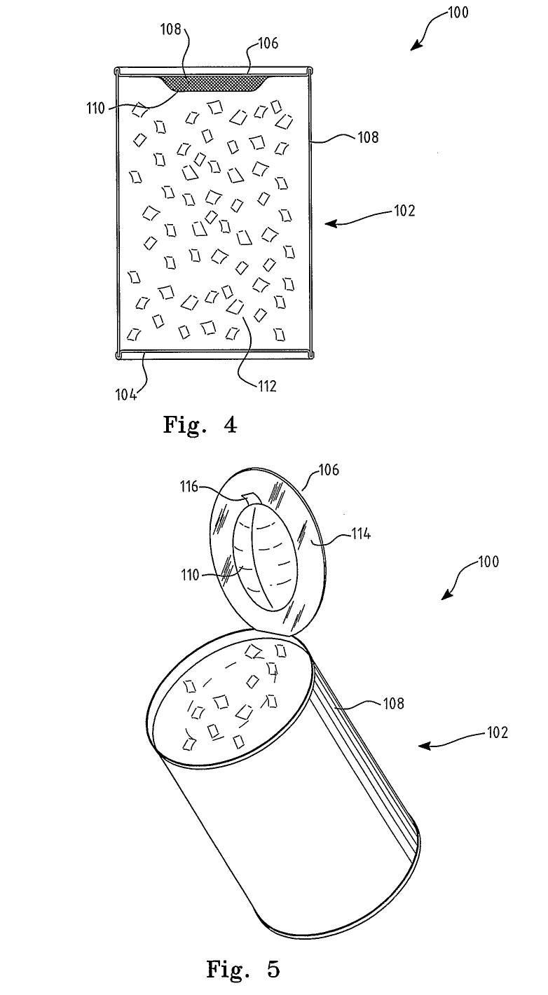

In a second preferred embodiment with reference to FIGS. 4 and 5, a packaging system 100 comprises a tin can 102 having bottom and top ends 104 and 106 respectively and cylindrical sides 108. In this embodiment, ancillary ingredients 108 or contained in a sachet 110 attached to the under side of top end 106. In this embodiment also, the volume of sachet 110 is sized relative to the volume of tin can 102 so as to provide a satisfactory effect of the ancillary ingredient on the primary ingredients 112 of the container when the contents of the sachet are applied to those primary ingredients.

In at least one preferred form of this embodiment, sachet 110 is detachable from the underside surface 114 of top end 106 by means of a pull-tab 116. Sachet 110 may then be opened by means of for example, an area of weakness susceptible to manipulation and parting so as to provide an opening in the sachet, or by cutting off a corner of the sachet with a suitable cutting instrument.

A sachet containing an ancillary ingredient may be attached to an inside surface of any suitable container of foodstuff, and need not be restricted to the containers of the two embodiments described above. Thus a sachet with flavouring for example may be attached to the inside of an ice cream container, or a variety of sauce may be supplied inside a tin of fish.

A particular primary ingredient may be suitable for consumption with a variety of ancillary ingredients. Primary containers may then be supplied with indicia indicating the nature of the particular ancillary ingredient contained in the sachet.

In further preferred embodiments of the present invention the sachet may be used as a carrier for supplements of vitamins as well as both preventative and curative medicinal compounds.

### Third Preferred Embodiment

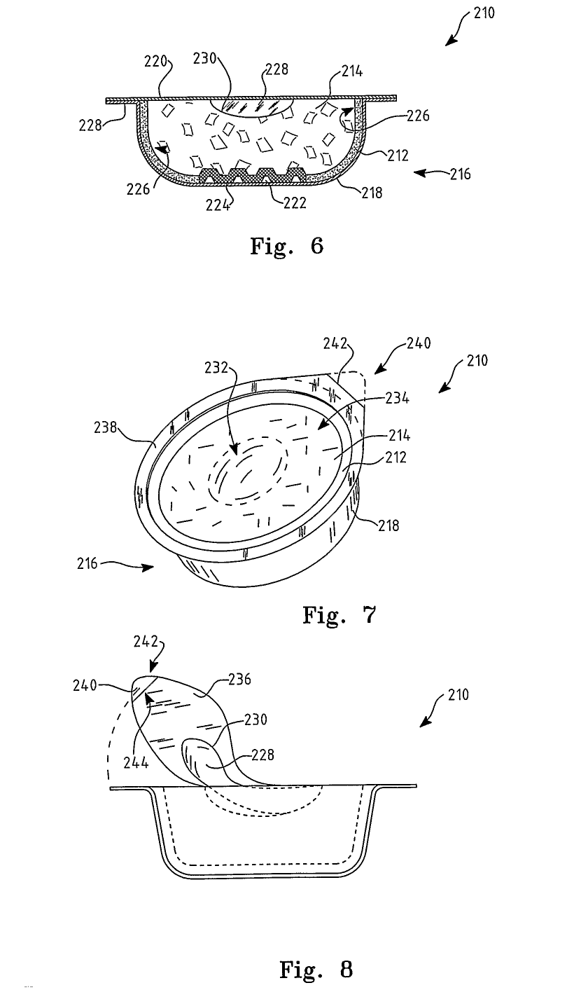

With reference to FIG. 6 a packaged edible composition of pet food 210 is comprised of an outer edible portion 212 and an inner edible portion 214 enclosed in a package 216 comprised of outer shell 218 and peel-off cover portion 220.

The edible outer portion 212 is, in at least one preferred form of this embodiment, composed of a layer of crust-like material forming a container adapted to at least partly enclose and retain the edible inner portion 214 such that the inner edible portion 214 is not in contact with the inner surface 222 of outer shell 218 of package 216. The layer of crust-like material may be a biscuit composition for example and is shaped to conform to the inner surface 222 of the outer shell 218 of package 216. In at least one further preferred form, the edible outer portion 212 may be a pastry type crust.

Preferably, though not necessarily, the base portion 224 of outer edible portion 212 is of a thicker or harder composition then the upwardly extending edge portions 226. In at least one preferred form, outer edible portion 212 or at least the base portion thereof is of a composition adapted to provide fiber in the diet of the animal.

Regardless of the composition of outer edible portion 212, it is adapted to retain its original shape as packaged as well as its properties of retention of the inner edible portion for the shelf life of the product. As well, its properties are such as to not stick to the inner surface 222 of the package so that both inner and outer edible portions are readily removable from the package when required for use and the shape of the edible composition retained until addressed by a consuming animal.

The inner edible portion 214 may be comprised of any suitable pet food such as for example chunks of meat held in a matrix of a gel and is formulated for properties of taste, texture and nutrition. Alternatively, the inner edible portion may consist of dry palletized food ingredients.

Also with reference to FIG. 6, packaged edible composition 210 includes a mixable separate food ingredient 228. Food ingredient 228 is contained in a sachet 230 and, as may best be seen in FIG. 7, is so arranged as to fill a depression 232 generally in the middle of the upper surface 234 of inner edible portion 214. In at least one preferred form of this embodiment as shown in FIG. 8, sachet 230 is attached to the underside 236 of peel-off cover portion 220 of package 216.

Separate food ingredient 228 may be a gravy for example or a sauce adapted to add flavour, moisture and nutrition to both the inner edible and outer edible portions of the edible composition. Separate food ingredient 228 may further be formulated as an additional protein source.

The outer shell 218 of package 216 is preferably formed of compactable and recycled plastic or foil. The peel-off cover portion 220 may be of a suitable foil or plastic sheet material and attached to the rim 238 of outer shell 218 by any suitable means such as for example, an adhesive, or heat or ultrasonic welding. For convenience, package 216 may be provided with an outwardly extending tab portion 240 on outer shell 218 (shown in broken outline in FIG. 7) and a corresponding tab portion 242 on peel-off cover portion 220 as best seen in FIG. 8. The base portion tab 240 may be provided with perforations 242 adapted to allow tab 240 to snap off when sufficient force is applied and, by remaining attached to the peel-off cover tab portion 242, provide a convenient grasping element allowing the peeling off of the cover 220.

Package 216 may be of any convenient shape such as circular as shown in FIGS. 6 to 8 for example, or it may be of oval, square, rectangular, diamond or cylindrical shape.

In use, the peel-off cover portion 220 is removed from the outer shell 218. This also pulls the sachet 230, if attached to the underside of the cover portion, from the depression 232 in inner edible portion 214. Edible outer portion 212 and edible inner portion 214 are then readily slid out of outer shell 218 of package 216 as a contiguous whole and cleanly deposited for example in the feed bowl of an intended animal consumer. The sachet 230, may then be pierced and its contents spread over the inner and outer edible portions.

### Fourth Preferred Embodiment

In a further preferred embodiment of the invention, the outer edible portion is provided as a complete enclosure of the inner edible portion, this being then comprised of a base portion and sides with a lid portion of the same edible composition.

A particular advantage of the arrangement is its improved shelf life.

### Fifth Preferred Embodiment

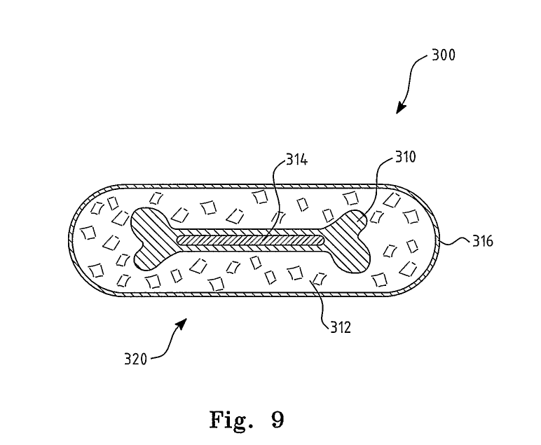

In yet a further preferred embodiment of the invention with reference to FIG. 9, an edible composition 300 comprised of an inner edible portion 310 in the form of a biscuit-like preparation and an outer edible portion 312 substantially in the form of a meat preparation.

Inner edible portion 310 may for example be shaped as a bone and in at least one preferred form of this embodiment, may include a central cavity 314 filled with an edible gel. The edible gel may range in consistency from a viscous slurry to a near solid.

Inner edible portion 310 is further preferably formulated so as to provide a source of carbohydrate and fiber to the animal and as well provide a chewable element conducive to its dental health.

Edible composition 300 in this embodiment is enclosed in packaging comprising a sheath or outer shell 316 of plastic, preferably to provide a sausage shaped package 320 provided with a tear open zipper (not shown). In use the zipper which extends substantially the length of the package is adapted to allow the whole of edible composition 300 to be ejected from the package for placement for example in the feed bowl of an intended animal consumer.

Edible composition may further be formulated for frozen or refrigerated storage prior to sale and prior to use.

### Sixth Preferred Embodiment

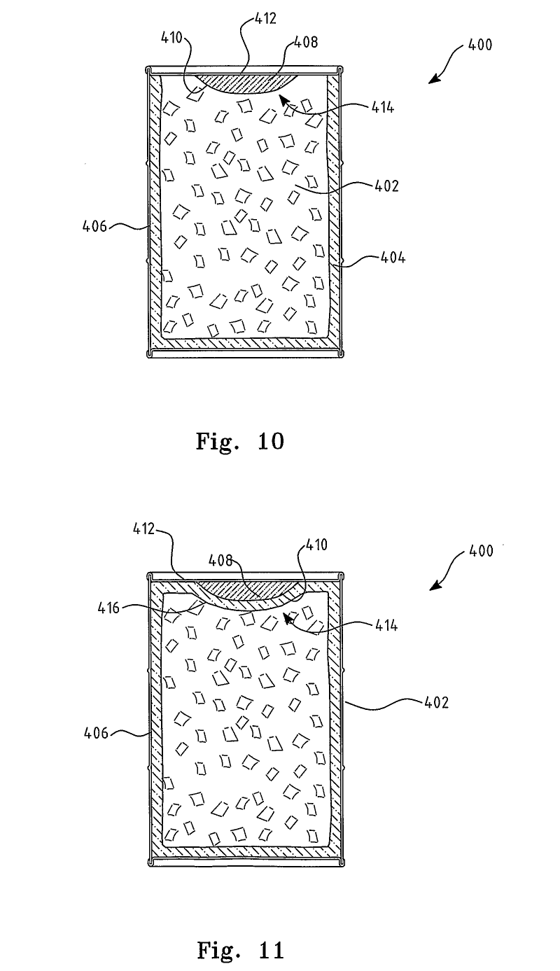

In a further preferred embodiment of the invention with reference to FIGS. 10 and 11, a packaged edible composition of pet food 400 is comprised of an inner edible portion 402 and an outer edible portion 404 enclosed in a cylindrical sealed can 406. Outer edible portion 404 in at least one preferred form of this embodiment is composed of a biscuit-like layer conforming to the inside surfaces of at least the sides and base of the can 406, but may also completely envelop inner edible portion 402 as shown in FIG. 11. The inner edible portion may then be comprised of any suitable pet food such as for example chunks of meat in a matrix of a gel. Alternatively, the inner edible portion could be in the form of dry palletized food ingredients.

In this preferred embodiment also, a mixable separate food ingredient 408 may be supplied in a separate sachet 410 retained between a circular upper end 412 of the can 406 and a depression 414, either in the upper surface of inner edible portion 414 or, as shown in FIG. 11, in a suitable depression in upper portion 416 of outer edible portion 404 where outer edible portion 404 completely encloses the inner edible portion 402.

Mixable separate food ingredient may be supplied in a sachet releasable attached to the inside of the circular upper end 412 so that when the lid is removed from the can the sachet is pulled from its retaining depression 414.

### Seventh Preferred Embodiment

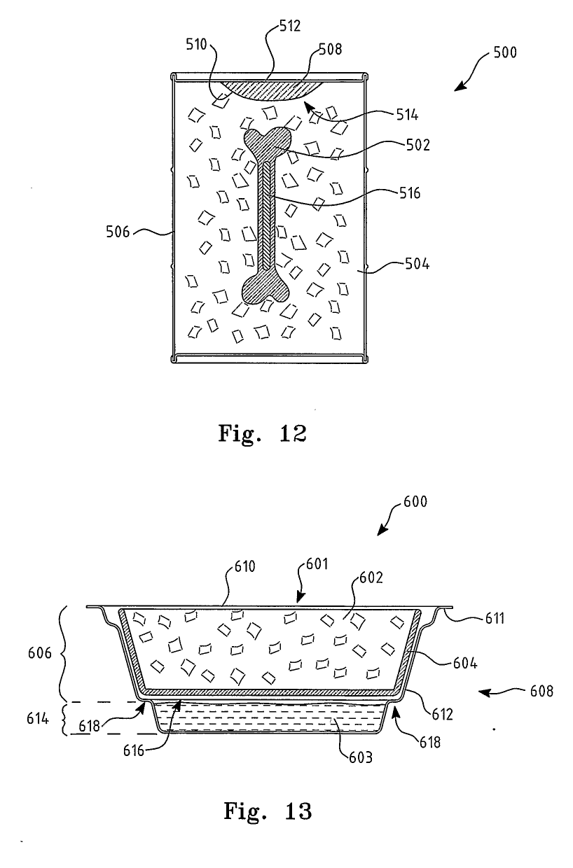

With reference to FIG. 12 packaged edible food composition 500 is provided in a cylindrical can 506 and comprises an outer edible portion 304 and an inner edible portion 502. In this embodiment it is the inner edible portion 502 which is composed of a biscuit-like material and may be formed for example in the shape of a bone. The outer edible portion 504 may then be comprised of any suitable pet food such as for example chunks of meat held in a matrix of a gel, but could also be comprised of dry pelletized food ingredients.

A mixable separate food ingredient 508 may be provided in a sachet 510 retained between the circular upper end 512 of can 506 and a depression 514 in the upper surface of outer edible food portion 504. In this embodiment also, the sachet 510 may be attached to the inside of circular upper end 512.

In at least one other preferred form of this embodiment the inner edible portion 502 may be provided with an internal cavity 516 adapted to contain a preferred food supplement such as for example a protein rich composition.

### Eighth Preferred Embodiment

With reference to FIG. 13, a packaged edible food composition 600 comprises at least two edible compositions 601 and 603. The first edible composition 601 shown in this embodiment, comprises an inner edible portion 602 and outer edible portion 604 retained in a first upper compartment 606 of packaging 608. Outer edible portion 604 at least partly encloses inner edible portion 602, and in the illustrated example comprises a base part and upwardly extending side portions to form a pie-like structure. Packaging 608 is sealed by a peel-off foil or plastic sheet 610 applied to the upper rim 611 of outer shell 612 of the packaging.

Located in a lower part of outer shell 612 is a second lower compartment 614 of packaging 608, separated from first upper compartment 606 by a peel-off foil or plastic sheet 616 applied to the inside surface of step or shoulder 618.

Outer edible portion 604 may again be formulated as a crust of biscuit-like or pie crust material, substantially conforming to the inner surfaces of the upper compartment 606, adapted to retain its shape and provide a receptacle for inner edible portion 602. Inner edible portion may be a meat and gel composition or comprise a dry kibble.

Second lower compartment 614 may then contain a separate food ingredient, for example a nutritional supplement in liquid or flowable form as a sauce or gravy, for addition to the contents of the first upper compartment 606.

In use, the foil or plastic sheet 610 is firstly peeled off the upper rim 611 and the outer and inner edible portions removed. The foil or plastic sheet 616 sealing the second section 614 can then be peeled off shoulder 618 to allow the application of the nutritional supplement or gravy. Alternatively, sheet 616 may be provided with a frangible line (not shown) along a central portion of its surface, which, with manipulation can be pierced to release the nutritional supplement, gravy or sauce retained in second section 614.

### Ninth Preferred Embodiment

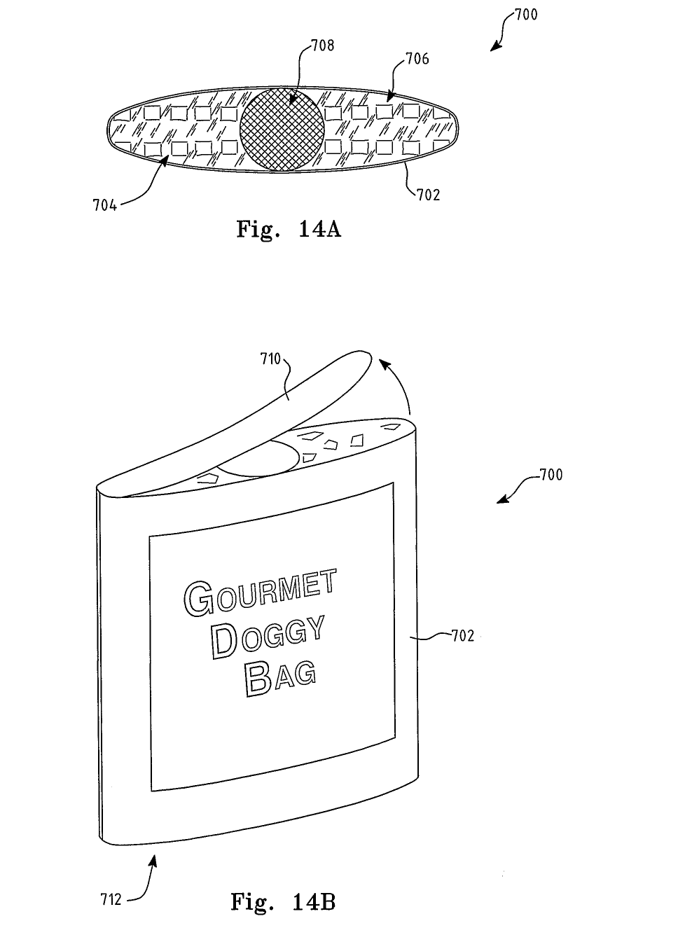

With reference to FIGS. 14A and 14B, an edible food composition 700 is provided in a foil sachet 702. Sachet 702 is in the form of an elongate sleeve of flattened oval section and is divided into two outer edible food portions 704 and 706 by a third, central inner edible food portion 708. Each end of sachet 702 is sealed by top and a bottom foil portions 710 and 712 respectively, with the top foil portion 712 arranged for tearing off for use.

The two outer edible portions 704 and 706 each comprise a substantially solid food composition of kibble pellets suspended in a matrix of nutritional gel, pre-moulded so as to leave between them, when inserted into sachet 702 a cylindrical cavity forming a third portion 708 which may then be filled with a flowable gravy, sauce or nutritional supplement, prior to sealing the sachet, to form an inner edible portion.

In one preferred form of this embodiment, outer edible portions 704 and 706 are separated by a tubular compartment for containing the flowable gravy. Each of the outer and the inner edible portions extend the length of the elongate sleeve of the sachet 702.

Preferably the two kibble-in-gel compositions are of different selected flavours. The sachet may be provided in a range of sizes so as to contain one complete meal for an intended pet animal.

### Tenth Preferred Embodiment

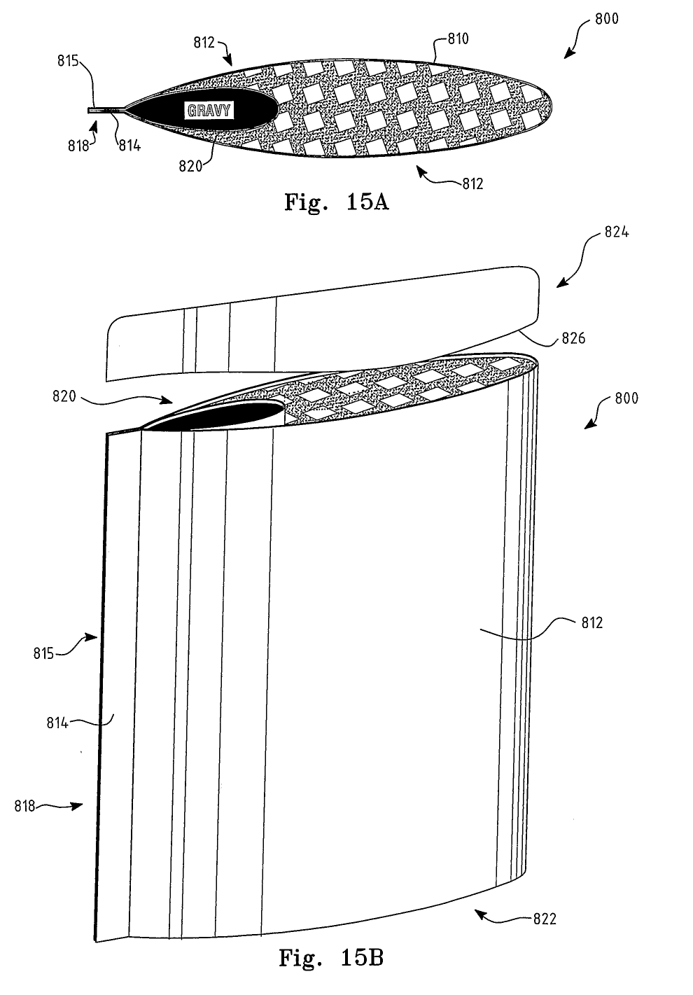

With reference to FIGS. 15A and 15B, an edible composition 800 is contained in an outer foil enclosure 810 forming an elongate oval sectioned shape as best seen in the sectioned view of FIG. 15A. Sides 812 are formed of a single sheet of foil wrapped to form the oval section shape with opposing edges 814 and 815 brought together to form a seam 818 extending the length of enclosure 810.

A similar but smaller dimensioned inner enclosure 820 is also formed from a single sheet of foil wrapped to form an oval section shape with the opposing edges of the sheet also brought together and held between edges 814 and 815 of the outer enclosure 810.

The several sheet edges of the inner and outer enclosures are joined together, for example by heat welding, to form an airtight common seam. A base portion 822 may be formed of a separate piece of foil heat welded to the lower edges of the sides of the outer and inner enclosures, but more preferably the lower edges of the two enclosures may be brought into contact and welded to form a lower airtight seam.

Similarly, the top 824 is also provided with an airtight closure, but here there is provided proximate to the upper end of the enclosures, a frangible tear line 826 or strip by means of which the upper portion of the enclosures may be detached so as to access the contents of the outer and inner enclosures for use.

Preferably, the smaller volume of the inner enclosure may contain a flowable nutritional supplement 828 such as a gravy, while the larger volume of the outer enclosure contains a relatively solid kibble composition. Flowable supplement 828 may be formulated to include particular dosage of vitamins or therapeutic substances.

Although the enclosure so far described is for a two part enclosure, it will be appreciated that the invention encompasses embodiments allowing for three separate compartments by the addition of a fourth sheet, for three distinct edible compositions.

### Eleventh Preferred Embodiment

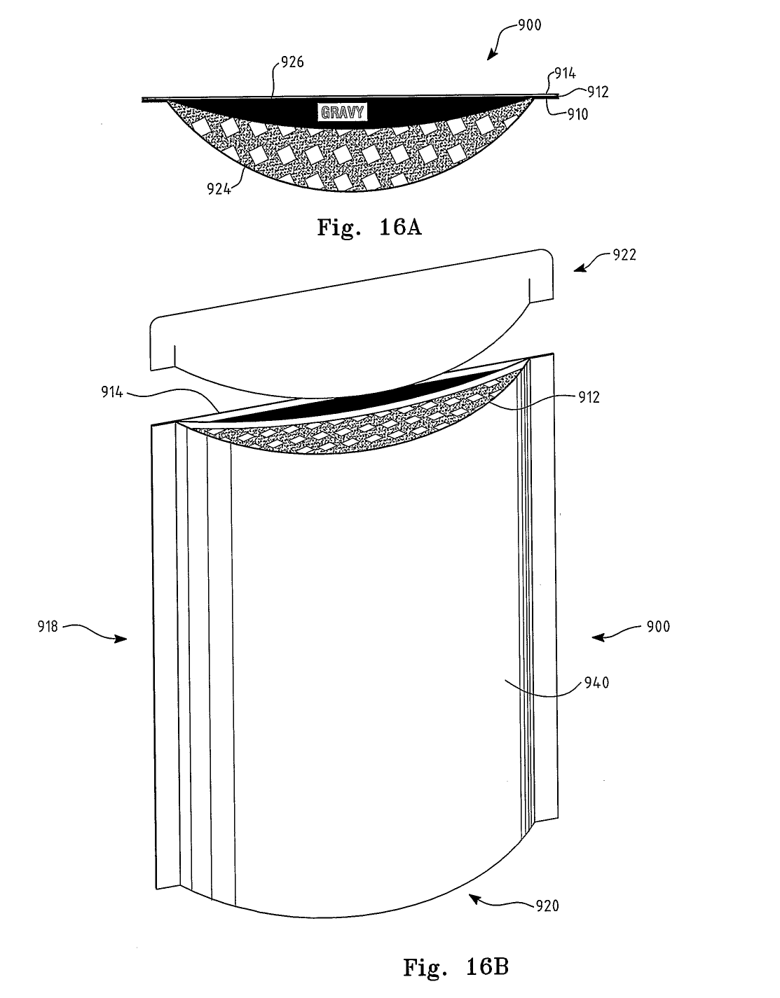

In this further preferred embodiment with reference to FIGS. 16A and 16B, a dual enclosure structure 900 is formed of three separate generally rectangular sheets of foil. A lower outer sheet 910, an intermediate sheet 912 and an upper outer sheet 914 as best seen in FIG. 16A.

The three sheets are gathered together at the opposing longer edges of the sheets and joined, for example by heat welding, to form airtight seams 916 and 918. Each of ends 920 and 922 are sealed, either by separate pieces of suitably shaped foil or by a gathering together of the corresponding opposing edges and forming airtight end seams. One end 922 is provided with a frangible line or strip by means of which that end of the enclosures may be removed to gain access to the contents.

The width of each sheet increases from the narrowest of sheet 914 to the widest of sheet 912, so that the “bellying” of lower outer sheet 910 and, to a lesser extent, that of intermediate sheet 912, form between them first volume 924 for a first edible composition and second volume 926 for a second edible composition respectively.

In this embodiment also, it will be appreciated that a third edible composition could be accommodated by providing a further internal looping sheet of foil.

### Twelfth Preferred Embodiment

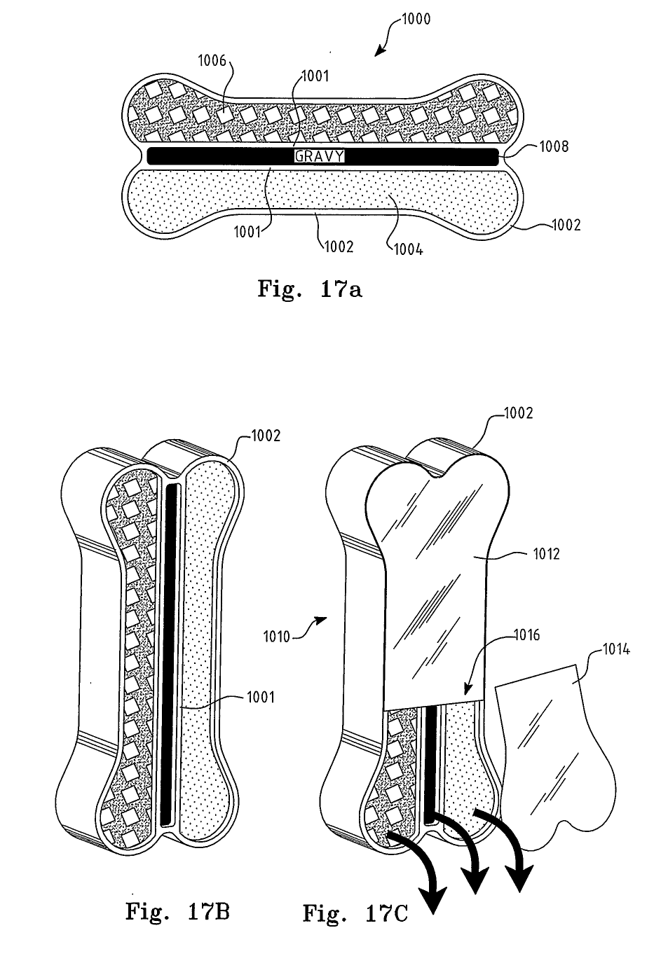

In a further embodiment of an edible composition and packaging with reference to FIGS. 17A to 17C, a package 1000 is formed in section as an outer shell 1002 with a traditional dog bone shape. Internally, the packaging is divided into three compartments by dividing elements 1001 to form larger volume outer compartments 1004 and 1006 and smaller volume middle compartment 1008.

Package 800 is preferably extruded in a relatively flexible plastic material and provided with a rear foil closure panel 1010 (hidden) and a front closure panel 1012. At least a portion 1014 of front panel 1012 is removable by tearing along a friable line or strip 1016. Alternatively, the base portion and outer shell 1002 and dividing elements 1001 may be integrally moulded.

The three compartments of packaging 1000 may be filled with three different edible compositions. Thus for example the two larger volume outer compartments 1004 and 1006 may contain a relatively solid kibble composition while the middle compartment 1008 is filled with a flowable substance such as a gravy. Alternatively, middle compartment 1008 could be used for providing a therapeutic substance either in addition to the flowable substance or as a powder for example.

When required for use, the pull-off portion 1014 of front panel 1012 is removed and the contents of the package may then be squeezed from it.

Although the example described above and illustrated in FIGS. 17A to 17C is for a dog bone shaped package, it will be readily understood that the internal arrangements may be incorporated in other shapes of packaging, such as for example a fish-shaped package for cat food.

### Thirteenth Preferred Embodiment

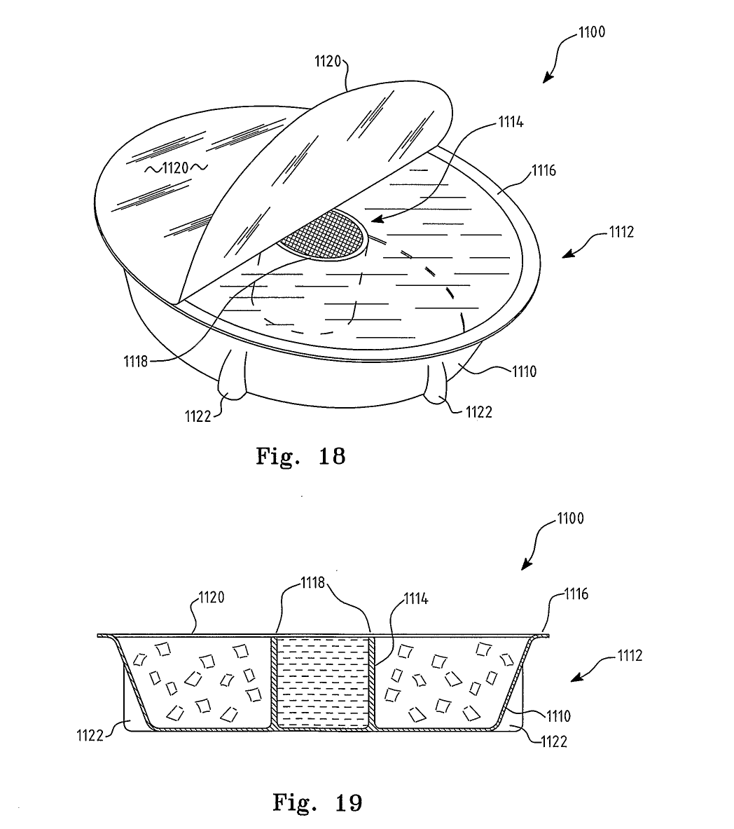

In still a further preferred embodiment of an edible composition and packaging 1100, with reference to FIGS. 18 and 19, an outer shell 1110 forms a bowl 1112 provided with an integrally formed internal receptacle 1114. The rims 1116 and 1118 of the outer shell 1110 and the internal receptacle 1114 respectively, lie in a common plane such that a cover portion 1120 can be sealably applied to both rims 1116 and 1118. The bowl portion 1112 may then be filled with, for example a kibble and gel food composition as described in previous embodiments above, and the internal receptacle 1114 filled with a flowable food composition such as a gravy or a nutritional supplement.

In one preferred form of this embodiment, the bowl may be provided with projecting stabilising elements 1122 as can be seen in FIGS. 18 and 19, allowing it to be used directly as a food bowl for the consuming animal.

### Fourteenth Preferred Embodiment

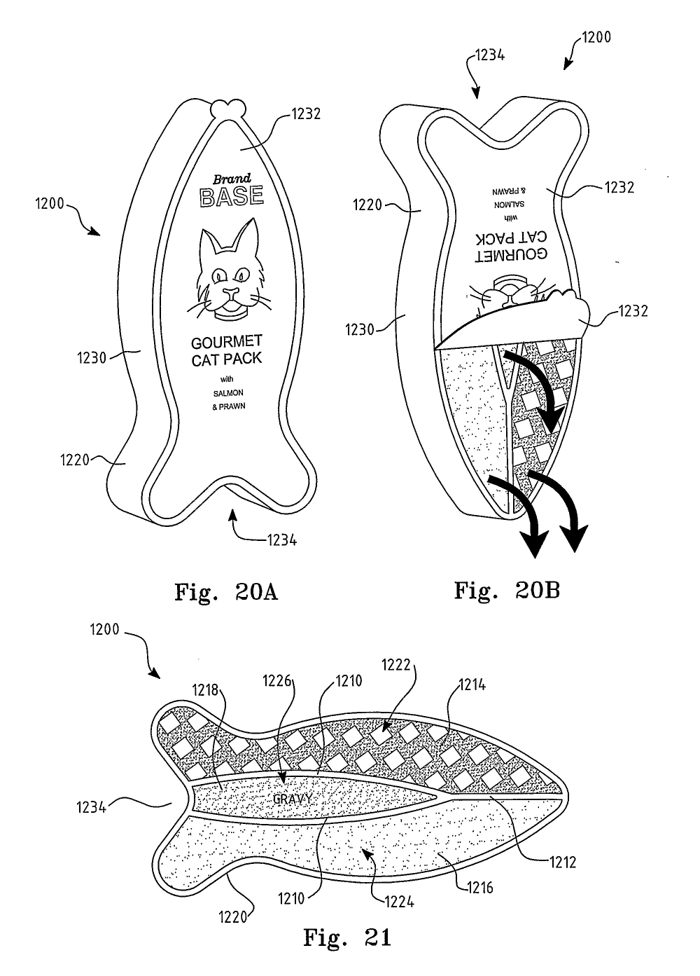

In this preferred embodiment shown in FIGS. 20A, 20B and FIG. 21, the arrangement of the packaging 1200 is similar to that described above for the twelfth embodiment, in that the packaging is provided with internal divisions 1210 and 1212 allowing the provision of three separate edible compositions 1214, 1216 and 1218 within the one package.

In a particularly preferred arrangement, the external shell 1220 of the packaging 1200, is shaped in section as the profile of a fish, and the contents intended primarily, though not necessarily, for consumption by cats.

The two outer compartments 1222 and 1224 provided by the internal divisions 1210 and 1212, allow for the provision of two edible compositions, such as two formulations of kibble and gel for example, while the middle smaller compartment 1226 may contain a gravy, sauce or some specific dietary or medicinal supplement. Alternatively, the middle compartment may contain a relatively solid edible composition with the two outer compartments containing flowable edible compositions.

As shown in FIGS. 20A and 20B, the packaging comprises the outer fish-shaped shell 1220, a fish-shaped base (not visible) with sides 1230 and internal divisions 1210 and 1212 rising upwardly from the base. The shell and its internal divisions may be formed by extrusion from a suitable plastic material for example, with the base formed of a foil or film applied to the base, either by an adhesive, heat sealing or other suitable means. Alternatively, the base, outer shell and internal divisions may be integrally moulded.

The upper edges of the outer shell 1220 and internal divisions 1210 and 1212 lie in a common plane substantially parallel to the base. After the contents have been added to the package, a film or foil sealing cover 1232 is adhesively or otherwise applied to the edges of the outer shell 1220 and internal divisions 1210 and 1212, so as to maintain separation between the disparate contents prior to use.

In a preferred arrangement of the consistencies of the three separate contents of the packaging 1200, the two outer edible compositions 1214 and 1216 are in a flowable state, as are the contents of the central smaller compartment 1226. By this means the contents of the two outer compartments 1224 and 1226 can first be discharged from the package by peeling back the film or foil cover 1232 as shown in FIG. 20B, by grasping the package by the “tail” 1234 and peeling the cover 1232 back far enough to allow flowing egress of the contents from the two outer compartments 1222 and 1224, thus delaying the egress of the contents of the central compartment 1226.

### Nutritional Structure

The composition of the various elements of the food ingredients of the above described embodiments rely on a balanced juxtaposition of nutritional structures. Broadly, these may be considered as consisting of three main sources comprising a carrier containing a protein source, a carrier containing a fibre source and a carrier containing a carbohydrate source.

The fibre and carbohydrate sources may primarily be provided in the biscuit-like portions of the packaged edible food compositions of the above described embodiments. The other edible portion may also provide both fibre and/or carbohydrate depending on the chosen composition of the suitable pet food. Likewise this portion will carry at least some of the protein.

### Composition of Supplement

Additional protein may be provided in the separate food ingredient of the gravy or sauce for example.

Alternatively, the sachet may be used in any one of the above embodiments as a carrier for additional vitamin supplements, or a conditioning, curative or preventative medicinal compound.

The above describes only some embodiments of the present invention and modifications, obvious to those skilled in the art, can be made thereto without departing from the scope and spirit of the present invention.

What is claimed is:

1. A packaging system for food stuff comprising a primary container and a secondary container wherein said primary container is adapted for enclosure of said secondary container; said secondary container attached to an openable portion of said primary container.

2. The system of claim 1 wherein said primary container is a plastic container provided with a plastic peel-off cover.

3. The system of claim 2 wherein said secondary container is a plastic sachet attached to the underside of said plastic peel-off cover.

4. The system of claim 2 wherein said sachet is provided with a line of weakness adapted to split so as to provide an opening in at least one surface of said sachet when said plastic peel-off cover and said sachet are suitably manipulated.

5. The system of claim 1 wherein said primary container is a tin can.

6. The system of claim 5 wherein said secondary container is a plastic sachet attached to the underside of one end of said tin can.

7. The system of claim 1 wherein said primary container is filled with prepared main ingredients for a meal.

8. The system of claim 1 wherein said sachet is filled with an ancillary ingredient.

9. The system of claim 8 wherein said ancillary ingredient is a sauce.

10-85. (canceled)

86. A packaging for a nutritional composition for animals; said packaging comprising at least a first sheet and a second sheet of a foil material; each said first sheet and said second sheet wrapped to form an elongate generally oval section envelope wherein corresponding pairs of opposing edges of each said sheet are brought together to form a common seam extending the length of said oval section so as to define a first inner enclosure and a second outer enclosure.

87. The packaging of claim 86 wherein upper and lower ends of each said elongate oval section of said inner and outer enclosures are sealed.

88. The packaging of claim 86 wherein an upper portion of said packaging is provided with a frangible area adapted for removal of said upper portion.

89. The packaging of claim 86 wherein said inner enclosure is adapted to contain a flowable nutritional substance; said second outer enclosure is adapted to contain a relatively solid kibble composition.

90. A packaging for a nutritional composition for animals; said packaging formed of layers of at least three generally rectangular sheets of a foil material; each of said sheets joined together at corresponding first pairs of opposing edges; and wherein dimensions between said first pairs of opposing edges of successive sheets increase from a first uppermost sheet to a lowermost sheet; said first uppermost sheet forming a generally flat surface with each successive lower sheet assuming a concave form so as to form a first enclosure between said uppermost sheet and an intermediate lower sheet and a second enclosure between said intermediate lower sheet and said lowermost sheet.

91. A packaging for a nutritional composition for animals; said packaging shaped in section as dog bone; said packaging divided into three compartments comprising two outer compartments and middle compartments; said packaging further comprising a rear closure panel and a front closure panel.

92. The packaging of claim 91 wherein said front closure panel includes a removable portion.

93. The packaging of claim 91 wherein said outer compartments are adapted to contain relatively solid kibble nutritional compositions; said middle compartment adapted to contain a flowable substance.

94. The packaging of claim 93 wherein said flowable substance is a gravy.

95. The packaging of claim 93 wherein said flowable substance is a therapeutic substance.

96. The packaging of claim 93 wherein said two outer compartments contain relatively flowable edible compositions.

97-101. (canceled)

102. A packaging containing at least two edible compositions for pet animals; said packaging in the form of a container comprising a base portion and side portions extending upwardly from said base portion; said container divided into an upper compartment containing a first of said at least two edible compositions, and a lower compartment containing a second of said at least two edible compositions; said upper compartment and said lower compartment separated by a dividing element; wherein a first of said at least two edible compositions comprises an outer edible portion at least partially enclosing an inner edible portion, and wherein a second of said at least two edible compositions comprises a flowable nutritional substance.

103. The packaging of claim 102 wherein said outer edible portion comprises a crust of biscuit-like material forming a base portion and at least upwardly extending side portions; said base portion and said side portions substantially conforming to inner surfaces of said upper compartment.

104-109. (canceled)
